(19) United States
(12) Patent Application Publication
(10) Pub. No.: US 2008/0165991 A1
(43) Pub. Date: Jul. 10, 2008

(54) DISPLAY DEVICE WITH SOUND MODULE

(75) Inventors: FANG-YUAN SHYU, Tu-Cheng (TW); MIN-HSIUNG HUNG, Tu-Cheng (TW); CHO-MING WU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/933,436

(22) Filed: Nov. 1, 2007

(30) Foreign Application Priority Data
Jan. 5, 2007 (CN) 200710072819.9

(51) Int. Cl. H04R 25/00; H04N 5/64; H04R 1/02

(52) U.S. Cl. 381/160; 381/150; 381/388; 348/836

(57) ABSTRACT

A display device includes a cabinet, a display screen, and a speaker. The display screen is accommodated in the cabinet. The display screen includes a display surface. The display surface is used for displaying video images. The speaker is accommodated in the cabinet, and used for generating sounds. The generated sounds disperse along a first direction substantially perpendicular to the display surface of the display screen.

### BACKGROUND

1. Field of the Invention

The present invention generally relates to display devices, and particularly, to a television or a monitor with a sound module arrangement.

2. Description of Related Art

Traditional cathode ray tube (CRT) type televisions are being replaced by flat-panel type televisions, such as liquid crystal display (LCD) televisions, plasma display panel (PDP) televisions, et al.

A typical flat-panel type television includes a display system and a sound system. The display system has a display screen for displaying video images. The sound system includes a pair of speakers for outputting sounds, and a sound reflector for transmitting the sounds. The speakers are usually located at a lower side of a cabinet of the television and are mounted on the sound reflector. The speakers are positioned obliquely relative to a surface normal to the display screen. A reflecting plate is disposed adjacent to the speakers for reflecting the sounds towards a front of the television. However, the inclined speakers under the display system still occupy space along an up-down direction, affecting a maximum display screen adoptable in the cabinet.

Therefore, what is needed in the industry is to provide a display device with a sound module which can more effectively utilize the dimension along the up-down direction.

### SUMMARY

Accordingly, a display device is provided. The display device includes a cabinet, a display screen, and at least one speaker. The display screen is accommodated in the cabinet. The display screen includes a display surface configured for displaying video images. The speaker is also accommodated in the cabinet, and is configured for outputting sounds. The sounds disperse along a first direction substantially parallel with the display surface of the display screen.

### BRIEF DESCRIPTION OF THE DRAWINGS

FIG. 1 is an isometric view of a display device with a sound module in accordance with a preferred embodiment;

FIG. 2 is an exploded, isometric view of the sound module in FIG. 1; and

FIG. 3 is sectional view of the assembled sound module along a line A-A in FIG. 2.

### DETAILED DESCRIPTION

Reference will now be made in detail to embodiments of the display device, examples of which are illustrated in the accompanying drawings.

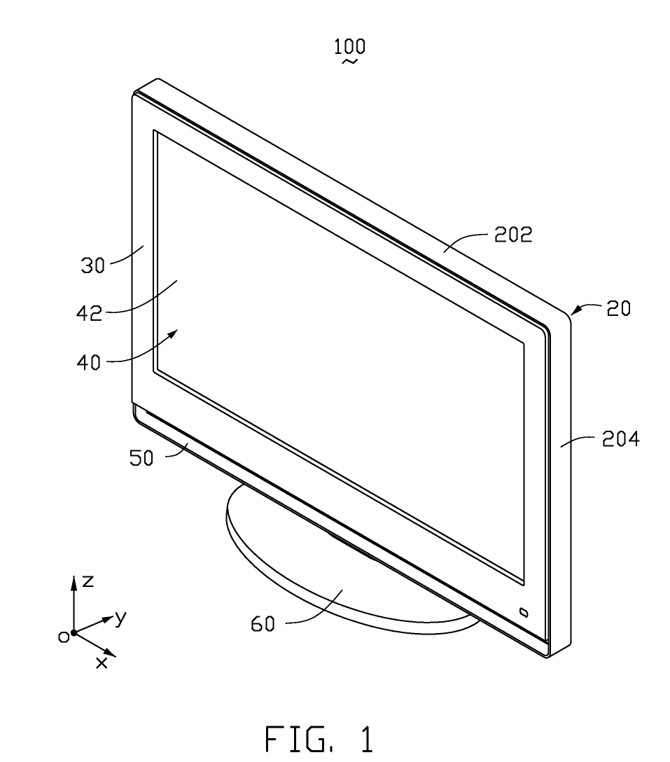

Referring to FIG. 1, a flat-panel type television 100, for example an LCD television, includes a cabinet 20, a cover plate 30, a display screen 40, a sound module 50, and a seat 60. The cabinet 20 includes a first surface 202 (top surface) and a second surface 204 (side surface). The top surface 202 extends horizontally as viewed from the front of the television 100. The side surface 204 extends substantially perpendicularly from the top surface 202.

The cover plate 30 is defined with a substantially rectangular opening (not labeled) in an approximately central portion with a size corresponding to a display size of the display screen 40. The cover plate 30 is coupled to the cabinet 20 by a latching mechanism or an adhering mechanism to secure the display screen 40 in the cabinet 20. The display screen 40 is accommodated in the cabinet 20, and includes a display surface 42 for displaying video images.

The sound module 50 is configured for outputting sounds by reflection. The sound module 50 is accommodated in the cabinet 20, and disposed under the display screen 40. The seat 60 adjacent to the sound module 50 is coupled to the cabinet 20 by a neck (not shown) for supporting the television 100.

For exemplary purposes, a three-dimensional coordinate system with three coordinate axes perpendicular with each other is defined, where an O-X axis runs perpendicularly with the side surface 204, an O-Y axis is runs perpendicularly with the display surface 42, and an O-Z axis runs perpendicularly with the top surface 202.

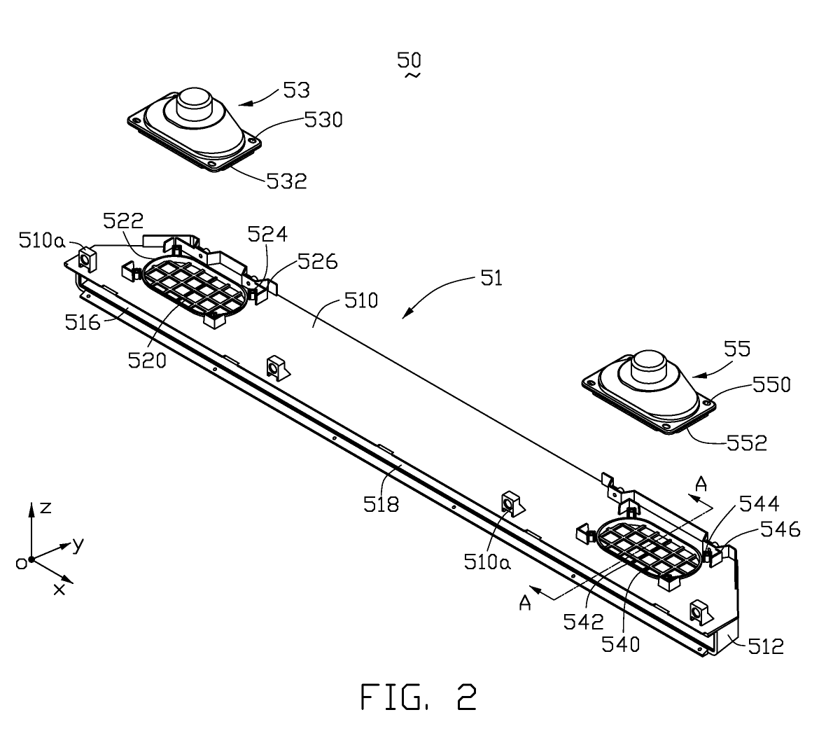

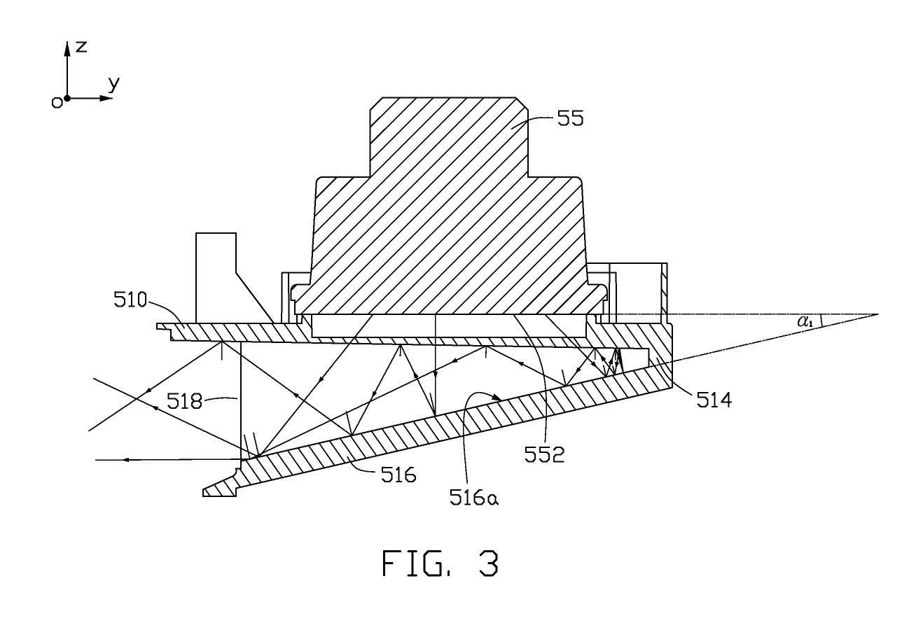

Referring to FIG. 2 and FIG. 3, the sound module 50 includes a sound reflector 51 and a pair of speakers 53, 55. The sound reflector 51 is configured for being mounted with the speakers 53, 55, and reflecting the sounds from the speakers 53, 55 outward.

The sound reflector 51 includes a supporting plate 510, a side plate 512, a rear plate 514, and a reflecting plate 516. The sound reflector 51 is constructed by interconnecting the supporting plate 510, the side plate 512, the rear plate 514, and the reflecting plate 516. The supporting plate 510 includes two screens 520, 540 formed at opposite ends of the supporting plate 510. Each of the screens 520, 540 is constructed by a plurality of intersecting bars (not labeled) extending in the O-X direction and the O-Y direction, such that the sounds can transmit therethrough. The reflecting plate 516 includes a reflecting surface 516a facing toward the supporting plate 510. The reflecting surface 516a is arranged at an acute angle α1 with the coordinate plane O-XY for changing a transmitting direction of the sounds by reflection. The supporting plate 510, the side plate 512, and the reflecting plate 516 define an opening 518 at front edges. The opening 518 is used for outputting the sounds outward substantially in the negative O-Y coordinate axis direction.

The sound module 50 is constructed by mounting the speakers 53, 55 on the sound reflector 51. Preferably, the speakers 53, 55 are substantially symmetrically distributed on the sound reflector 51. The screens 520, 540 of the sound reflector 51 are covered by the speakers 53, 55 respectively. When the speakers 53, 55 output sounds, the sounds are transmitting substantially along the negative O-Z axis direction. The generated sounds then travel through the screens 520, 540 towards the reflecting surface 516a. The sounds are then reflected by the reflecting surface 516a, and deflected towards the negative O-Y axis direction. Thus, the sounds from the speakers are directed to the front of the television 100 at the opening 518. As the sounds generated from the speakers 53, 55 have a predetermined divergence angle, such that a portion of the sound waves may be reflected out directly. Another portion of the sound waves may be reflected by the reflecting plate 510 and the supporting plate 516 several times until being outputted from the opening 518.

The dimension of the speakers 53, 55 being arranged parallel to the sound reflector 51 along the O-Z axis direction is more compacted than the dimension when the speakers 53, 55 are inclined arranged relative to the reflector 51. Such that, when the sound module 50 is accommodated in the television 100, more space can be utilized for optimizing the image size of the display screen 40.

In addition, each of the speakers 53, 55 defines a plurality of locking holes 530, 550. Flanges 522, 542 surrounding the corresponding screen 520, 540 protrude from the supporting plate 510. The flanges 522, 542 are configured for supporting the speakers 53, 55 thereon respectively. A plurality of locking posts 524, 544 protrude from the supporting plate 510 adjacent to outer edges of the flanges 522, 542. By receiving the locking posts 522, 544 of the sound reflector 51 in the locking holes 530, 550 of the speakers 53, 55 respectively, the speakers 53, 55 are mounted on the sound reflector 51. A plurality of positioning members 526, 546 are located on the supporting plate 510 adjacent the locking posts 524. The positioning members 526, 546 are L-shaped, conforming to outer edges configuration of the speakers 53, 55 respectively, for further stably mounting the speakers 53, 55 to the sound reflector 51. A plurality of locking members 510a is formed on the supporting plate 510. The locking members 510a are used for fastening the sound reflector 51 to the cabinet 20 of the television 100.

It should be noted that in alternative embodiments the sound module can be disposed above, on the left, or on the right of the display screen 40 as viewed from the front of the television 100. In these alternative embodiments, the transmitting direction of the sounds from the speakers 53, 55 are also substantially parallel with the display surface 42 of the display screen 40.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display device, comprising:
a cabinet;
a display screen accommodated in the cabinet, the display screen comprising a display surface configured for displaying video images thereon; and
at least one speaker accommodated in the cabinet configured for generating sounds, the generated sounds dispersing along a first direction substantially parallel with the display surface of the display screen.

2. The display device as claimed in claim 1, wherein the display device comprises a reflecting plate, the reflecting plate is configured for reflecting the sounds to be transmitting along a second direction, the second direction is substantially perpendicular to the first direction.

3. The display device as claimed in claim 1, wherein the display device comprises a supporting plate, the supporting plate is configured for mounting the speakers thereon.

4. The display device as claimed in claim 3, wherein the supporting plate includes at least a screen covered by the corresponding speaker, the screen is configured for passing the sounds generated from the speaker therethrough.

5. The display device as claimed in claim 3, wherein the speaker is located substantially under the display screen.

6. A display device, comprising:
a cabinet comprising at least one first surface extending in a left-right direction as viewed from a front from the display device, and at least one second surface extending perpendicularly to the first surface;
at least one speaker incorporated in the cabinet, the speaker configured for generating sounds, the generated sounds transmitting along a first direction substantially perpendicular to one of the first surface and the second surface of the cabinet;
a supporting plate for supporting the speaker thereon, the supporting plate being connected to the cabinet, and being substantially perpendicular to one of the first surface and the second surface of the cabinet; and
a reflecting plate coupled to the supporting plate for reflecting the sounds to be transmitting along a second direction substantially parallel with one of the first surface and the second surface of the cabinet.

7. The display device as claimed in claim 6, wherein the display device comprises a display screen, the display screen comprises a display surface for displaying video images thereon, the first direction along which the sounds transmit is substantially parallel with the display surface.

8. The display device as claimed in claim 6, wherein the supporting plate comprises at least a screen, the screen is configured for passing the sounds generated by the speaker therethrough.

9. The display device as claimed in claim 7, wherein the speaker is disposed substantially below the display screen.

10. A display device for display video images on a display screen, comprising:
at least a speaker for producing sounds signaled by audio signals;
a sound reflector for being mounted the speaker thereon, the sound reflector comprising:
a mounting plate comprising at least a screen for transmitting the sounds produced from the speaker therethrough along an up-down direction that parallel with the display screen;
a rear plate with one end connected to the mounting plate; and
a reflecting plate connected to the other end of the rear plate, the reflecting plate configured for changing the transmitting direction of the sounds, an opening being defined by front edges of the mounting plate and the reflecting plate for outputting the sounds after the sounds being reflected by the reflecting plate along a horizontal plane perpendicular to the up-down direction.

11. The display device as claimed in claim 10, wherein the reflecting plate comprises a reflecting surface facing toward the mounting plate, the reflecting surface is inclined relative to the horizontal plane.

12. The display device as claimed in claim 10, wherein the display device comprises a cabinet, the cabinet is configured for accommodating the speaker therein.

13. The display device as claimed in claim 12, wherein at least a locking member protrudes from the mounting plate, which is fastened to the cabinet by fastening the locking member to the cabinet.

14. The display device as claimed in claim 12, wherein the speaker is disposed substantially under the display screen.

15. The display device as claimed in claim 10, wherein the speaker is defined with at least a locking hole, and at least a locking post protrudes from the mounting plate, the speaker is mounted to the mounting plate by receiving the locking posts in the locking hole.

16. The display device as claimed in claim 10, wherein at least a flange surrounding the screen protrudes from the mounting plate for supporting the speaker thereon.

17. The display device as claimed in claim 10, wherein at least a positioning member adjacent to the locking post protrudes from the mounting plate, the positioning is configured for restricting the speaker from moving relative to the mounting plate.
